(19) United States
(12) Patent Application Publication
(10) Pub. No.: US 2007/0221096 A1
(43) Pub. Date: Sep. 27, 2007

(54) Novel Polyimide Film

(76) Inventors: Kan Fujihara, Shiga (JP); Kazuhiro Ono, Shiga (JP); Takaaki Matsuwaki, Shizuoka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 11/571,334

(22) PCT Filed: Jun. 21, 2005
(86) PCT No.: PCT/JP05/11328

§ 371 Date: Dec. 27, 2006

(30) Foreign Application Priority Data
Jun. 29, 2004 (JP) 2004-191692

(51) Int. Cl. C08J 5/12

(52) U.S. Cl. 106/287.3

(57) ABSTRACT

A polyimide film that can provide a flexible metal-clad laminate plate which causes no significant dimensional change upon etching of the metal layer. The polyamide film is characterized in that, in the whole width of a continuously produced polyimide film, the ratio of the coefficient of humidity expansion (b) in a direction perpendicular to a molecular orientation axis and the coefficient of humidity expansion. (a) in the direction parallel to the molecular orientation axis, i.e., b/a, is not less than 1.01 to not more than 2.00 and the difference between the maximum value of the coefficient of humidity expansion ratio and the minimum value of the coefficient of humidity expansion ratio is not more than 0.30. The polyimide film in another aspect is characterized in that the coefficient of humidity expansion in a direction parallel to the molecular orientation axis is not less than 3.0 ppm/° C. and not more than 15.0 ppm/% RH, the difference between the maximum value and the minimum value for the molecular orientation angle of the film is not more than 40°, and the molecular orientation angle is regulated within 0±20° when MD direction is 0°.

### TECHNICAL FIELD

The present invention relates to a polyimide film whose ratio of a coefficient of humidity expansion (b) in a direction perpendicular to a molecular orientation axis to a coefficient of humidity expansion (a) in a direction parallel to the molecular orientation axis is controlled within a particular range. In particular, the present invention relates to a polyimide film for electric/electronic device substrate applications, such as flexible printed circuit boards, TAB tapes, and solar cell substrates, high-density recording medium applications, and magnetic recording medium applications. With this polyimide film, it is possible to suppress the ratio of change in dimensions that occurs during a step of forming a metal layer, in particular, a step of laminating a metal foil under heating, or a step of etching the metal layer and to stabilize the physical properties (ratio of change in dimensions) across an entire width of the film.

### BACKGROUND ART

In the field of electronics, demand for higher density mount is stronger than ever. In the field that uses, for example, flexible printed circuit boards (hereinafter, referred to as “FPCs”), this demand has also led to requirements of physical properties that can satisfy the demands for higher density mount.

A process for producing an FPC can be roughly divided into (1) a step of laminating a metal on a base film and (2) a step of forming wiring of a predetermined pattern in the surface of the metal. In particular, in the process of producing an FPC for high-density mount, changes in dimensions of the base film (e.g., changes in dimensions during heating and changes in dimensions before and after etching of a copper foil) are desirably as small as possible.

In addition, in the production of an FPC by processing a wide base film through a roll-to-roll process to laminate a metal onto the base film, the base film is required to exhibit stable physical properties across the entire width, i.e., stable ratios of change in dimensions across an entire width of the base film.

Polyimide films are typically produced by a tenter furnace method in which ends of the film are held with clips or pin seats and then the film is baked as it passes through a high-temperature furnace. However, when polyimide films are produced by the tenter furnace method, a phenomenon similar to a generation of anisotropic molecular orientation (This phenomenon is usually known as bowing phenomenon) described in Non patent Citation 1 and 2 occurs during the production of the polyimide film. As a result, anisotropic molecular orientation is generated in the end portions of the film (in particular, in regions within about 100 mm from the units for holding the film).

Present inventors have conducted various analyses on polyimide films that experienced the bowing phenomenon and that were produced by a continuous process. As a result, it was found that when FPCs are produced from such films, a ratio of change in dimensions at end portions is high and the uniformity of the ratio of change in dimensions in the film surface is low. The inventors have found that a polyamide film whose ratio of a coefficient of humidity expansion (b) in a direction perpendicular to a molecular orientation axis to a coefficient of humidity expansion (a) in a direction parallel to the molecular orientation axis is controlled within a particular range exhibits smaller changes in dimensions and stable ratios of change in dimensions across the entire width of the polyimide film.

With respect to changes in dimensions, Patent Citation 1 and 2 describe that the dimensional changes in TAB tapes can be decreased by decreasing a coefficient of humidity expansion of the tapes.

Patent Citation 3 describes a polyimide film having a coefficient of humidity expansion of 3 to 50 ppm/%RH and that a smaller coefficient of humidity expansion increases the stability of dimensional changes versus humidity.

However, none of the above-described Patent Citations and Non Patent Citations describes a polyimide film having a controlled ratio of a coefficient of humidity expansion (b) in a direction perpendicular to a molecular orientation axis to a coefficient of humidity expansion (a) in a direction parallel to the molecular orientation axis within a particular range. Polyimide films in Patent Citations and Non Patent Citations are different from the present invention.
Patent Citation 1: Japanese Unexamined Patent Application Publication Nos. 10-298286 0006
Patent Citation 2: Japanese Unexamined Patent Application Publication Nos. 2000-80165 0007
Patent Citation 3: Japanese Unexamined Patent Application Publication No. 11-59986 0023
Non Patent Citation 1: K. Sakamoto, “Kobunshi Ronbun Shu [Japanese Journal of Polymer Science and Technology]” vol. 48, No. 11, pp. 671-678 (1991)
Non Patent Citation 2: Nonomura et al., “Seikei-Kakou [Processing and forming of materials]”, vol. 4, No. 5, pp. 312-317 (1992)

In other words, with polyimide films known heretofore, it has not been possible to suppress the ratio of change in dimensions that occurs in the process of producing flexible printed circuit boards or the like (e.g., the step of forming a metal layer, the step of laminating a metal foil under heating, or the step of etching the metal layer). In particular, it has been difficult to sufficiently decrease the ratios of change in dimensions in the center and end portions and to decrease the difference in ratio of change in dimensions between the center portion and the end portions. Moreover, during the process of producing FPCs using polyamide base films, e.g., before and after the step of laminating a metal on a base film or before and after the step of forming wiring of a predetermined pattern in the surface of the metal, it has been difficult to reduce dimensional changes. In particular, when a wide base film is processed by a roll-to-roll process to laminate a metal, the resulting polyimide film does not exhibit stable physical properties (ratio of change in dimensions) across an entire width of polyamide film.

### SUMMARY OF THE INVENTION

The present invention is directed to overcoming the problems encountered in the related art by providing a novel polyimide film and a laminate incorporating the novel polyimide film described below.

(1) the present invention provides a polyimide film produced by a continuous process, wherein the ratio ((b)/(a)) of a coefficient of humidity expansion (b) in a direction perpendicular to a molecular orientation axis to a coefficient of humidity expansion (a) in a direction parallel to the molecular orientation axis is 1.01 to 2.00 across an entire width of the polyimide film, and a difference between a maximum coefficient of humidity expansion ratio and a minimum coefficient of humidity expansion ratio is 0.30 or less.

(2) Preferably, the polyimide film according to (1), wherein the coefficient of humidity expansion in the direction parallel to the molecular orientation axis is 3.0 ppm/%RH to 15.0 ppm/%RH across the entire width of the polyimide film.

(3) More preferably, the polyimide film according to (1) or (2), wherein the difference between a maximum molecular orientation angle and a minimum molecular orientation angle of the polyimide film is 40° or less across the entire width of the polyimide film.

(4) Most preferably, the polyimide film according to one of (1) to (3) wherein a molecular orientation angle of the polyimide film is within 0±20° with respect to a machining direction, where the machining direction is 0° (MD direction) of the continuous process for making the polyimide film across the entire width of the polyimide film.

(5) the present invention provides a laminate incorporating the polyimide film according to one of (1) to (4).

The present invention provides the polyimide film produced by a continuous process, wherein a coefficient of humidity expansion ratio (b)/(a) between a coefficient of humidity expansion (b) in a direction perpendicular to a molecular orientation axis and a coefficient of humidity expansion (a) in a direction parallel to the molecular orientation axis is 1.01 to 2.00 across an entire width of the polyimide film, and a difference between a maximum coefficient of humidity expansion ratio and a minimum coefficient of humidity expansion ratio is 0.30 or less. When this polyimide film is used as the base film of an FPC, the changes in dimensions that occur during the production process can be decreased, and the ratio of change in dimensions across the entire width of the polyimide film can be reduced. Accordingly, a high-quality FPC capable of high-density mount can be produced.

### BEST MODE FOR CARRYING OUT THE INVENTION

In the carrying out the invention below, the present invention will be described in detail in the order of a polyimide film of the present invention, a representative example of a method for producing the polyimide film of the present invention, and a laminate incorporating the polyimide film of the present invention.

Polyimide Film of the Present Invention

A polyimide film of the present invention is suitable as base films for electric/electronic device substrate applications, such as flexible printed circuit boards, TAB tapes, and solar cell substrates, high-density recording medium applications, and magnetic recording medium applications. The polyimide film of the present invention has stable physical properties across the entire width of the polyimide film and decreased dimensional changes before and after the step of laminating a metal foil under heating or the step of etching the metal foil.

In producing FPCs, one approach is to use a polyimide film while taking into account the expected changes in dimensions of the base film. For example, when the FPCs are to be exposed to high temperature during the production or when dimensional changes are expected to occur by etching, the estimate of the changes in dimensions of the polyimide film is assumed in advance. Provided that the ratio of change in dimensions of the base film is stable across the entire width, it becomes possible to estimate the ratio of change in dimensions based on a correction coefficient. Thus, it becomes easier to control the overall dimensional changes that occur by exposure to high temperature or etching described above, Consequently, for example, formation of wiring pattern in a metal layer of a metal-clad laminate constituted from a polyimide film and a metal layer covering the entire width is facilitated, and a yield is improved. Moreover, the reliability of the pattern connections and therefore the quality of FPCs can be greatly improved.

However, when changes in dimensions vary across the width of the polyimide film, estimation of dimensional changes is difficult. The polyimide film of the present invention does not require screening of portions having stable dimensional changes. Thus, unusable portions to be discarded can be decreased, and the yield can be increased.

Furthermore, the molecular orientation angle of the polyimide film is preferably 0±20° across the entire width, where a machining direction (MD direction) of the continuous process is 0°. This will be described in detail below. By using this film, dimensional changes can be reduced when the film is bonded with a metal foil with an adhesive layer therebetween by a hot-roll lamination system of continuous heating and pressurizing the foil and the film, The hot-roll lamination system of bonding the metal foil frequently puts the materials under a heating environment while a tension is being applied to the materials. This is the reason why the ratio of change in dimensions is important. The polyimide film of the present invention can stabilize the ratio of change in dimensions across the entire width.

In order to stabilize the physical properties, when measuring the ratio between the coefficient of humidity expansions (a) in a direction parallel to the molecular orientation axis and (b) in a direction perpendicular to the molecular orientation axis should be restricted within a predetermined range at least across the entire width of the polyimide film. Furthermore, the upper limit of the difference between the maximum and minimum coefficient of humidity expansion ratios should be restricted. In addition to these two conditions, the molecular orientation angle across the entire width of the polyimide film should be regulated. The polyimide film satisfying these conditions can exhibit increased dimensional stability and is suitable as a base film for FPCs. These conditions will be described in detail below.

Coefficient of humidity expansion (a) in Direction Parallel to a Molecular Orientation Axis, coefficient of humidity expansion (b) in Direction Perpendicular to the Molecular Orientation Axis, and Ratio (b)/(a)

The polyimide film of the present invention is produced by a continuous process. Here, the coefficient of humidity expansion (a) in a direction parallel to a molecular orientation axis and the coefficient of humidity expansion (b) in a direction perpendicular to the molecular orientation axis are measured across the entire width of the polyimide film. A coefficient of humidity expansion ratio (b)/(a) is preferably 1.01 to 2.00, and more preferably 1.01 to 1.90.

The polyimide film of the present invention produced by a continuous process preferably has a length of 1,000 mm or more and a width of 100 mm or more since the effects of the invention are particularly outstanding. More preferably, the width is 400 mm or more and most preferably 1,000 mm or more. It should be understood here that the polyimide film of the present invention produced by the continuous process includes a film slit in a longitudinal direction or a transverse direction to a predetermined value after the production.

The term “entire width” refers to the portion from one edge to the opposite edge of the polyimide film produced by a continuous process. The physical properties across the entire width of the film are determined by analyzing three samples respectively taken from one end portion, a center portion, and the other end portion of the polyimide film and comparing and utilizing the observed values.

In the present invention, the term “molecular orientation axis” refers to a direction in which the degree of molecular orientation is the largest in an X-Y plane wherein the X axis is the longitudinal direction of the film, the Y axis is the transversal direction of the film, and the Z axis is the thickness direction of the film. The molecular orientation axis can be determined by any common analyzer. For example, in this invention, molecular orientation analyzer MOA2012A or MOA6015 produced by Oji Scientific Instruments was used to determine the molecular orientation axis.

In order to measure the coefficient of humidity expansion (a) in a direction parallel to the molecular orientation axis and the coefficient of humidity expansion (b) in a direction perpendicular to the molecular orientation axis, respectively, of the polyimide film, the molecular orientation axis is determined first using the above-described device. 40 mm×40 mm samples are respectively taken from the two end portions and the center portion of the polyamide film, and the molecular orientation axis of each sample is analyzed. When the width of the film is not large enough, samples are preferably taken while shifting the position in the MD direction. For example, when the film width is 100 mm, the samples are preferably taken while shifting the position in the MD direction as shown in FIG. 1.

Next, as shown in FIG. 2, specimens (2 mm×17 mm) respectively cut out in directions parallel and perpendicular to the molecular orientation axis are taken from each sample, and the coefficient of humidity expansion of each specimen is measured as follows. First, the humidity elongation ratio of the specimen is determined. In detail, while varying the moisture as shown in FIG. 3, the change in humidity and a percentage of elongation of the polyimide film sample are measured simultaneously, and the humidity elongation ratio is calculated by the equation below:
Humidity elongation ratio={amount (d) of elongation by moisture absorption/(initial length of sample)}/change (b) in humidity

Based on the humidity elongation ratio calculated by the above-described equation, a coefficient of humidity expansion is calculated by the equation below:
Coefficient of humidity expansion ={humidity elongation ratio}×10⁶
In the equation, the change (b) in humidity is set to 40 RH % (measurement was carried out under such condition that lower humidity was 40 RH % and higher humidity was 80 RH %). The amount (d) of elongation of the polyimide film was measured under a 3 g load.

The measurement system of the coefficient of humidity expansion is shown in a schematic diagram of FIG. 4. The coefficient of humidity expansion measurement system includes a thermostatic chamber 99 (a thermostatic bath and a hot water bath for temperature control), a sample chamber 98, a sample elongation analyzer (a detector 103 and a recording unit 104), a water vapor generator (a nitrogen bubbler 92, a heater 93 for generating water vapor, and water 94 for vapor generation), a humidity control unit (a humidity sensor 100 and a humidity converter 101).

The thermostatic chamber 99 adjusts (controls the temperature) the temperature of measuring the coefficient of humidity expansion. Hot water is fed from an inlet of hot water 96 in the direction indicated by the arrow and discharged from an outlet of hot water in a direction 95 indicated by the arrow, thereby controlling the temperature. Hot water is heated to 50° C. in a separate chamber and circulated in the chamber to control the temperature. The temperature of the thermostatic chamber is maintained at 50° C.

In order to control the humidity in the sample chamber, the water vapor generator and the humidity control unit are connected to the sample chamber. The sample chamber is the region defined by a glass vessel disposed in the thermostatic chamber.

The interior of the sample chamber can be humidified with a sample 97 of the polyimide film being placed in the sample chamber. The humidity in the sample chamber 98 is monitored with the humidity sensor 100, and the monitored humidity is analyzed in the humidity converter 101. The humidity converter 101 turns on the heater 93 when the humidity is not sufficiently high and turns off the heater 93 when the humidity is too high to control the humidity inside the sample chamber 98. The humidity converter 101 is computer-controlled, and adjusts the humidity according to the preset values of humidity set at predetermined times.

The amount of elongation of the sample inside the sample chamber 98 occurring with changes in humidity is detected with the detector, and the length of the sample is determined in the recording unit. Note that the recording unit 104 is also connected to the humidity converter 101 so that the change in humidity and the amount of elongation of the sample can be recorded simultaneously.

The specific structures of the detector 103, the recording unit 104, the water vapor generator, and the humidity control unit are not particularly limited. Any known device may be used. For example, the recording unit for determining the amount of length (elongation) of the polyimide film may be TMA (TMC-140) produced by Shimadzu Corporation.

In the present invention, in order to decrease the ratio of change in dimensions, it is important to adjust the coefficient of humidity expansion ratio determined by the following equation to 1.01 to 2.00 and preferably 1.01 to 1.90 based on the coefficient of humidity expansion (a) in a direction parallel to the molecular orientation axis of the polyimide film and the coefficient of humidity expansion (b) in a direction perpendicular to the molecular orientation axis.
coefficient of humidity expansion ratio=(b)/(a) (equation 1)

By controlling the coefficient of humidity expansion ratio of the polyimide film within the above-described range, the ratio of change in dimensions of the polyimide film can be suppressed, and the physical properties of the film in the transverse direction can be stabilized.

In the present invention, the difference between a maximum coefficient of humidity expansion ratio and a minimum coefficient of humidity expansion ratio is preferably 0.30 or less. In this way, the ratio of change in dimensions can be decreased, and the variation in physical properties in the film width direction can be decreased advantageously. In the present invention, the phrase “the difference between a maximum coefficient of humidity expansion ratio and a minimum coefficient of humidity expansion ratio” refers to the value calculated by equation below:
Difference between a maximum coefficient of humidity expansion ratio and a minimum coefficient of humidity expansion ratios=A maximum coefficient of humidity expansion ratio−a minimum coefficient of humidity expansion ratio (equation 2)
wherein the maximum coefficient of humidity expansion ratio is the largest ratio of those of the samples taken from the two ends of the polyimide film and the center of the polyimide film, and the minimum coefficient of humidity expansion ratio is the smallest ratio of those of these samples.
Coefficient of humidity expansion in Direction Parallel to Molecular Orientation Axis

A smaller coefficient of humidity expansion of the polyimide observed by the above-described process can reduce changes in dimensions that would occur in a step of heating in forming and processing a metal-clad laminate and a steps of etching, washing, and drying of a copper-clad laminate. Accordingly, the density and fineness of the metal pattern formed on the surface of the polyimide film can be improved, and the reliability of the wiring can be advantageously increased.

In a solder reflow process, the film is immersed in a solder bath after the moisture absorption or moisture desorption, and then an IC, for example, is mounted. The smaller the changes in dimensions of the polyimide film during the moisture absorption or dehumidification, the lower the incidence of the connection failure. Thus, a polyimide film having a small coefficient of humidity expansion has been desired. The coefficient of humidity expansion in the direction parallel to the molecular orientation axis is thus preferably within 3.0 ppm/% RH to 15.0 ppm/% RH and more preferably within 4.0 ppm/% RH to 13.0 ppm/% RH across the entire width.

Molecular Orientation Angle

In the polyimide film of the present invention, in addition to restricting the coefficient of humidity expansion ratio (b)/(a), the difference between the coefficient of humidity expansion ratios, and the coefficient of humidity expansion in the direction parallel to the molecular orientation axis, the difference between the maximum and minimum molecular orientation angles across the entire width of the polyimide film is preferably controlled to 40° or less. In this manner, the ratio of change in dimensions can be decreased, and the variation in physical properties in the width direction of the film can be decreased. In this invention, the molecular orientation angle is defmed as an angle between the axis of the MD direction and the observed molecular orientation axis. When the molecular orientation angle of the polyimide film is 0°, the molecular orientation axis is parallel to the MD direction (same direction as 11 shown in FIG. 5). A plus molecular orientation angle (12 in FIG. 5) indicates that the molecular orientation axis is shifted from the MD direction counterclockwise. A minus molecular orientation angle (13 in FIG. 5) indicates that the molecular orientation axis is shifted from the MD direction clockwise. In this invention, the molecular orientation angular difference is calculated from equation (3) below based on the largest plus molecular orientation angle and the largest minus molecular orientation angle observed in the direction of the film width. When only plus molecular orientation angles are observed in the film width direction, equation (4) is used. When only minus molecular orientation angles are observed in the film width direction, equation (5) is used. When the maximum or the minimum molecular orientation angle is 0° and the maximum molecular orientation angle is also 0°, the molecular orientation angular difference is calculated by equation 6 based on the minimum minus molecular orientation angle. When 0° is the minimum angle, the difference is determined by equation (7) based on the maximum plus molecular orientation angle.
Molecular orientation angular difference=(plus molecular orientation angle)−(minus molecular orientation angle) (equation 3)
Molecular orientation angular difference=(maximum plus molecular orientation angle)−(minimum plus molecular orientation angle) (equation 4)
Molecular orientation angular difference=(minimum minus molecular orientation angle)−(maximum minus molecular orientation angle) (equation 5)
Molecular orientation angular difference=0−(minimum minus molecular orientation angle) (equation 6)
Molecular orientation angular difference=(maximum plus molecular orientation angle) (equation 7)

In the present invention, the “molecular orientation angular difference” refers to a value calculated by one of the equations above based on the molecular orientation angles observed in the two end portions and the center portion of the polyimide film.

The direction of the molecular orientation angle may be any as long as the molecular orientation angular difference is 40° or less and preferably 30° or less. When the difference between the maximum and minimum molecular orientation angles is 40° or less, the variation in dimensional changes across the entire width of the film can be advantageously decreased.

In the present invention, the molecular orientation angle of the polyimide film is preferably 0±20° across the entire width with respect (0°) to the machining direction (MD direction) of the polyimide film (see 11 in FIG. 5). This can be explained with reference to FIG. 5 illustrating the relationship between the film machining direction (MD direction) and the molecular orientation angle. When the molecular orientation angle of the polyimide film is 0°, the axis of the molecular orientation is parallel to the MD direction (11 in FIG. 5). When the molecular orientation angle is 20°, the axis is shifted counterclockwise from the MD direction by 20° (12 in FIG. 5 is 20°). When the molecular orientation angle is −20°, the axis is shifted clockwise from the MD direction by 20° (13 in FIG. 5 is −20°). In other words, that “the molecular orientation is controlled within the preferable range, i.e., 0±20°, means that the axis of the molecular orientation is controlled within 20° with respect to the MD direction both clockwise and counterclockwise.

An example of the method for producing a metal-clad laminate using a polyimide base film includes applying an adhesive onto the polyimide film and thermally compressing a metal foil onto the polyimide film According to this method, the polyimide film is stretched in the MD direction and is contracted in the TD direction by a heat-bonding device during the thermocompression bonding When the molecular orientation axis is controlled within 0±20°, the film can be uniformly stretched in the MD direction across the entire width. For example, the elongation ratio of the film across the entire width can be more easily controlled for a film having a width of 100 mm or more. In this manner, one-side elongation and curling of the film that would occur as a result of different elongation ratios at the two end portions of the film in stretching under heating can be suppressed. Thus, the molecular orientation angle is preferably controlled within this range.

Film Thickness

The thickness of the film is preferably 1 to 200 μm, and more preferably 1 to 100 μm. Since a thin polyimide film facilitates the control of the molecular orientation angle of the polyimide film, the thickness is preferably 200 μm or less and more preferably 100 μm or less.

Process for Producing Polyimide Film of the Present Invention

The process for producing the polyimide film of the present invention is not particularly limited. The type of polyimide resin is also not particularly limited. One approach of obtaining a polyimide film having a coefficient of humidity expansion ratio (b)/(a) within 1.01 to 2.00, wherein (a) is an observed coefficient of humidity expansion in the direction parallel to the molecular orientation axis and (b) is an observed coefficient of humidity expansion in the direction perpendicular to the molecular orientation axis, is to alter the conditions of the film production. For example, in order to obtain the target polyimide film, a production process includes the steps of:

(A) preparing polyamic acid by polymerization;

(B) flow-casting a composition containing the polyamic acid and an organic solvent onto a support to form a gel film;

(C) peeling the gel film from the support and fixing the two ends of the film; and

(D) transferring the film with the fixed ends through a heating furnace. The polyimide film may be produced by adequately controlling the conditions of these steps and/or by adding an additional step to the process. The conditions that can be altered and production examples are described below.

Step (A)

In step (A), polyamic acid is prepared by polymerization, The polyamic acid may be prepared by a known process. Typically, substantially equimolar amounts of at least one aromatic tetracarboxylic dianhydride and at least one aromatic diamine are dissolved in an organic solvent to prepare an organic solvent solution, and this solution is stirred at under controlled temperature conditions until the polymerization of the aromatic tetracarboxylic dianhydride and the aromatic diamine is complete. The organic solvent solution usually has a solid content of 5 to 40 wt % and preferably 10 to 30 wt %. A solid content within this range can yield an adequate molecular weight and solution viscosity. Various 10 known methods may be employed as the polymerization method. In particular, preferable polymerization processes are as follows:

1) A process including dissolving an aromatic diamine in an organic polar solvent and reacting the aromatic diamine with a substantially equimolar amount of an aromatic tetracarboxylic dianhydride to conduct polymerization;

2) A process including reacting an aromatic tetracarboxylic dianhydride and fewer moles of an aromatic diamine in an organic polar solvent to prepare a prepolymer having acid anhydride groups at the both ends and polymerizing the prepolymer with an aromatic diamine so that the aromatic tetracarboxylic dianhydride and the aromatic diamine are substantially equimolar over the whole process;

3) A process including reacting an aromatic tetracarboxylic dianhydride and excess moles of an aromatic diamine in an organic polar solvent to prepare a prepolymer having amino groups at the both ends, adding an additional aromatic diamine to the prepolymer, and then polymerizing aromatic tetracarboxylic dianhydride so that the aromatic tetracarboxylic dianhydride and the aromatic diamine are substantially equimolar over the whole process to conduct polymerization;

4) A process including dissolving and/or dispersing an aromatic tetracarboxylic dianhydride in an organic polar solvent and polymerizing the aromatic tetracarboxylic dianhydride with a substantially equimolar amount of an aromatic diamine; and

5) A process including reacting a substantially equimolar mixture of an aromatic tetracarboxylic dianhydride and an aromatic diamine in an organic polar solvent to conduct polymerization.

Preferable examples of the organic solvent for preparing polyamic acid by polymerization include, but are not limited to, aprotic solvents, e.g., ureas such as tetramethylurea and N,N′-dimethylethylurea, sulfoxides or sulfones such as dimethylsulfoxide, diphenylsulfone, and tetramethylsulfone, amides, such as N,N′-methylacetamide (referred to as DMAc), N,N′-dimethylformamide (referred to as DMF), N-methyl-2-pyrrolidone (referred to as NMP), γ-butyrolactone, and hexamethylphosphoric triamide, and phosphoryl amide; alkyl halides such as chloroform and methylene chloride; aromatic hydrocarbons such as benzene and toluene; phenols such as phenol and cresol; and ethers such as dimethyl ether, diethyl ether, and p-cresol methyl ether. These organic solvents are usually used alone but may be used in combination. Among these organic solvents, aprotic polar solvents are preferable. In particular, the amides such as DMF, DMAc, and NMP are preferable for their high dissolubility of polyamic acid.

The aromatic tetracarboxylic dianhydride used as the starting material monomer of the polyamic acid is not particularly limited. Examples thereof include p-phenylene bis(trimellitic monoester anhydride), p-methylphenylene bis(trimellitic monoester anhydride), p-(2,3-dimethylphenylene) bis(trimellitic monoester anhydride), 4,4′-biphenylene bis(trimellitic monoester anhydride), 1,4-naphthalene bis(trimellitic monoester anhydride), and 2,6-naphthalene bis(trimellitic monoester anhydride), 2,2-bis(4-hydroxyphenyl)propane dibenzoate-3,3′,4,4′-tetracarboxylic dianhydride. Further examples thereof include aromatic tetracarboxylic acids such as ethylenetetracarboxylic acid, 1,2,3,4-butanetetracarboxylic acid, cyclopentanetetracarboxylic acid, pyromellitic acid, 1,2,3,4-benzenetetracarboxylic acid, 3,3′,4,4′-biphenyltetracarboxylic acid, 2,2,3,3-biphenyltetracarboxylic acid, 3,3′,4,4′-benzophenonetetracarboxylic acid, 2,2′,3,3′-benzophenonetetracarboxylic acid, bis(2,3-dicarboxyphenyl)methane, bis(3,4-dicarboxyphenyl)methane, 1,1-bis(2,3-dicarboxyphenyl)ethane, 2,2-bis(3,4-dicarboxyphenyl)propane, 2,2-bis(2,3-dicarboxyphenyl)propane, bis(3,4-dicarboxyphenyl) ether, bis(2,3-dicarboxyphenyl) ether, bis(2,3-dicarboxyphenyl) sulfone, 2,3,6,7-naphthalenetetracarboxylic acid, 1,4,5,8-naphthalenetetracarboxylic acid, 1,2,5,6-naphthalenetetracarboxylic acid, 2,3,6,7-anthracenetetracarboxylic acid, 1,2,7,8-phenanthrenetetracarboxylic acid, 3,4,9,11-perylenetetracarboxlic acid, 4,4-(p-phenylenedioxy)diphthalic acid, 4,4-(m-phenylenedioxy)diphthalic acid, and 2,2-bis[(2,3-anhydrous dicarboxyphenoxy)phenyl]propane; and the aromatic tetracarboxylic dianhydrides of these acids.

At least one of these compounds is preferably used. Furthermore, any one of these compounds may be singularly used, or an adequate combination of two or more of these compounds may be used.

Of these, aromatic tetracarboxylic acids such as pyromellitic acid, 1,2,3,4-benzenetetracarboxylic acid, 3,3′,4,4′-biphenyltetracarboxylic acid, 2,2′,3,3′-biphenyltetracarboxylic acid, 3,3′,4,4′-benzophenonetetracarboxylic acid, 2,2′,3,3′-benzophenonetetracarboxylic acid, and p-phenylene bis(trimellitic monoester acid), and their dianhydrides are particularly preferable.

These acid dianhydrides improve the elasticity modulus of the polyamide film. In a polyimide film having an improved elasticity modulus, contraction stresses are generated in the film surface by contraction in volume due to the evaporation of the residual volatile component, and the contraction stresses promote the molecular orientation in the surface. As a result, the ratio of the coefficient of humidity expansion (b) in the direction perpendicular to the molecular orientation axis to the coefficient of humidity expansion (a) in the direction parallel to the molecular orientation axis, i.e., the ratio (b)/(a), can be easily controlled. This also facilitates control of the molecular orientation axis and the molecular orientation angle.

Examples of the aromatic diamines used as a starting material monomer for the polyamic acid include, but are not limited to, p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfide, 3,4′-diaminodiphenyl sulfide, 4,4′-diaminodiphenyl sulfide, 3,3′-diaminodiphenylsulfone, 3,4′-diaminodiphenylsulfone, 4,4′-diaminodiphenylsulfone, 3,3′-diaminobenzophenone, 3,4′-diaminobenzophenone, 4,4′-diaminobenzophenone, 3,3′-diaminodiphenylmethane, 3,4′-diaminodiphenylmethane, 4,4′-diaminodiphenylmethane, 2,2-bis(4-aminophenyl)propane, 2,2-bis(3-aminophenyl)propane, 2-(3-aminophenyl)-2-(4-aminophenyl)propane, 2,2-bis(4-aminophenyl)-1,1,1,3,3,3-hexafluoropropane, 2,2-bis(3-aminophenyl)-1,1,1,3,3,3-hexafluoropropane, 2-(3-aminophenyl)-2-(4-aminophenyl)-1,1,1,3,3,3-hexafluoropropane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,4-bis(3-aminobenzoyl)benzene, 1,3-bis(4-aminobenzoyl)benzene, 1,4-bis(4-aminobenzoyl)benzene, 3,3′-diamino-4-phenoxybenzophenone, 4,4′-diamino-5-phenoxybenzophenone, 3,4′-diamino-4-phenoxybenzophenone, 3,4′-diamino-5-phenoxybenzophenone, 4,4′-bis(4-aminophenoxy)biphenyl, 3,3′-bis(4-aminophenoxy)biphenyl, 3,4′-bis(3-aminophenoxy)biphenyl, bis[4-(4-aminophenoxy)phenyl] ketone, bis[4-(3-aminophenoxy)phenyl] ketone, bis[3-(4-aminophenoxy)phenyl] ketone, bis[3-(3-aminophenoxy)phenyl] ketone, 3,3′-diamino-4,4′-diphenoxydibenzophenone, 4,4′-diamino-5)5′-diphenoxybenzophenone, 3,4′-diamino-4,5′-diphenoxybenzophenone, bis[4-(4-aminophenoxy)phenyl] sulfide, bis[3-(4-aminophenoxy)phenyl] sulfide, bis[4-(3-aminophenoxy)phenyl] sulfide, bis[3-(4-aminophenoxy)phenyl] sulfide, bis[3-(3-aminophenoxy)phenyl] sulfide, bis[3-(4-aminophenoxy)phenyl] sulfone, bis[4-(4-aminophenyl)] sulfone, bis[3-(3-aminophenoxy)phenyl] sulfone, bis[4-(3-aminophenyl)] sulfone, bis[4-(3-aminophenoxy)phenyl] ether, bis[4-(4-aminophenoxy)phenyl] ether, bis[3-(3-aminophenoxy)phenyl] ether, bis[4-(3-aminophenoxy)phenyl]methane, bis[4-(4-aminophenoxy)phenyl]methane, bis[3-(3-aminophenoxy)phenyl]methane, bis[3-(4-aminophenoxy)phenyl]methane, 2,2-bis[4-(3-aminophenoxy)phenyl]propane, 2,2-bis[4-(4-aminophenoxy)phenyl]propane, 2,2-bis[3-(3-aminophenoxy)phenyl]propane, 2,2-bis[4-(3-aminophenoxy)phenyl]-1,1,1,3,3,3-hexafluoropropane, 2,2-bis[4-(4-aminophenoxy)phenyl]-1,1,1,3,3,3-hexafluoropropane, 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 1,4-bis[4-(3-aminophenoxy)benzoyl]benzene, 1,3-bis[4-(3-aminophenoxy)benzoyl]benzene, 1,3-bis(3-amino-4-phenoxybenzoyl)benzene, 1,4-bis(3-amino-4-phenoxybenzoyl)benzene, 1,3-bis(4-amino-5-phenoxybenzoyl)benzene, 1,3-bis(4-amino-5-biphenoxybenzoyl)benzene, 1,4-bis(4-amino-5-biphenoxybenzoyl]benzene, 1,3-bis(3-amino-4-biphenoxybenzoyl)benzene, 1,4-bis(3-amino-4-biphenoxybenzoyl)benzene, 1,4-bis[4-(4-aminophenoxy)-α,α-dimethylbenzyl]benzene, 1,3-bis[4-(4-aminophenoxy)-α,α-dimethylbenzyl]benzene, 1,3-bis[4-(4-amino-6-trifluoromethylphenoxy)-α,α-dimethylbenzyl]benzene, 1,3-bis[4-(4-amino-6-fluoromethylphenoxy)-α,α-dimethylbenzyl]benzene, 1,3-bis[4-(4-amino-6-methylphenoxy)-α,α-dimethylbenzyl]benzene, 1,3-bis[4-(4-amino-6-cyanophenoxy)-α,α-dimethylbenzyl]benzene, and diaminopolysiloxane.

At least one of these compounds is preferably used. Furthermore, any one of these compounds may be singularly used, or an adequate combination of two or more of these compounds may be used.

In particular, it is preferable to use at least one selected from the group consisting of p-phenylenediamine, m-phenylenediamine, 3,3′-diaminodiphenyl ether, 3,4′-diaminodiphenyl ether, 4,4′-diaminodiphenyl ether, and 2,2-bis[4-(4-aminophenoxy)phenyl]propane so as to increase the heat resistance of the polyimide film and impart rigidity to the film. By incorporating p-phenylenediamine and/or 3,4′-diaminodiphenyl ether as the essential components, the elasticity modulus of the polyimide film can increased, and the ratio of the coefficient of humidity expansion (b) in the direction perpendicular to the molecular orientation axis to the coefficient of humidity expansion (a) in the direction parallel to the molecular orientation axis, i.e., the ratio (b)/(a), can be easily controlled within the preferable range.

In particular, the following combinations of the aromatic tetracarboxylic dianhydrides and the aromatic diamines are preferable as the starting material monomers since the molecular orientation angle of the resulting polyimide film can be easily controlled within the preferable range.

These combinations are: (1) a combination of p-phenylenediamine, 4,4′-diaminodiphenyl ether, pyromellitic dianhydride, and p-phenylene bis(trimellitic monoester anhydride); (2) a combination of p-phenylenediamine, 4,4′-diaminodiphenyl ether, pyromellitic dianhydride, and 3,3′,4,4′-biphenyltetracarboxylic dianhydride; (3) a combination of p-phenylenediamine, 4,4′-diaminodiphenyl ether, pyromellitic dianhydride, and 3,3′,4,4′-benzophenonetetracarboxylic dianhydride; (4) a combination of p-phenylenediamine, 4,4′-diaminodiphenyl ether, pyromellitic dianhydride, p-phenylene bis(trimellitic monoester anhydride), and 3,3′,4,4′-biphenyltetracarboxylic dianhydride; (5) a combination of p-phenylenediamine, 4,4′-diaminodiphenyl ether, and 3,3′,4,4′-biphenyltetracarboxylic dianhydride; (6) a combination of 4,4′-diaminodiphenyl ether, 3,4′-diaminodiphenyl ether, and pyromellitic dianhydride; (7) a combination of p-phenylenediamine and 3,3′,4,4′-biphenylteracarboxylic dianhydride; and (8) a combination of p-phenylenediamine, 4,4′-diaminodiphenyl ether, 2,2-bis[4-4-aminophenoxylphenyl]propane, pyromellitic dianhydride, and 3,3′,4,4′-benzophenonetetracarboxylic dianhydride. With these combinations, the molecular orientation angle and the coefficient of humidity expansion of the resulting polyimide film can be controlled within preferable ranges.

The elasticity modulus of the polyimide film of the present invention is preferably high from the standpoint of controlling the molecular orientation angle within the preferred range. In particular, the elasticity modulus can be increased by using p-phenylenediamine as the diamine starting material, and/or pyromellitic dianhydride, p-phenylene bis(trimellitic monoester anhydride), 3,3′,4,4′-biphenyltetracarboxylic dianhydride, or 3,3′,4,4′-benzophenonetetracarboxylic dianhydride as the aromatic tetracarboxylic dianhydride starting material.

The average molecular weight of the resulting polyamic acid is preferably 10,000 or more in terms of PEG (polyethylene glycol) by GPC from the standpoint of physical properties of the film.

The polyamic acid solution is kept warm in a 23° C. water bath for 1 hour and analyzed with a B-type viscometer and a No. 7 rotor at 4 rpm to determine the viscosity. The viscosity is preferably 50 Pa·s to 1,000 Pa·s, more preferably 100 Pa·s to 500 Pa·s, and most preferably 200 Pa·s to 350 Pa·s so that the handling during the film production can be facilitated.

The solid content of the polyamic acid in the polyamic acid solution is 5 to 40 wt %, preferably 10 to 30 wt %, and more preferably 13 to 25 wt %. Within these ranges, the handling during the film production can be facilitated.

Step (B)

In step (B), a composition containing the polyamic acid and an organic solvent (this composition is hereinafter also referred to as “polyamic acid solution”) is flow-cast on a support to form a gel film. The composition in step (B) may contain additives, such as a reactant reactive with the polyamic acid.

The viscosity and concentration of the polyamic acid solution may be adequately adjusted by adding an organic solvent similar to the polymerization solvent for preparing polyamic acid described above in step (A).

A known process may be employed to produce a polyimide film from the polyamic acid solution. The process is roughly categorized into thermal imidization and chemical imidization.

In thermal imidization, imidization is conducted solely by heating. The heating conditions vary according to the type of the polyamic acid, the thickness of the film, and the like. Preferably, a releasing agent, an imidization catalyst, and the like may be adequately added to the polyamic acid solution to conduct imidization. In chemical imidization, a solution of polyamic acid in an organic solvent is interacted with a dehydrator and an imidization catalyst. Examples of the dehydrator include aliphatic acid anhydrides such as acetic anhydride and aromatic acid anhydrides such as benzoic anhydride. Examples of the imidization catalyst include aliphatic tertiary amines such as triethylamine, aromatic tertiary amines such as dimethylaniline, and heterocyclic tertiary amines such as pyridine, picoline, and isoquinoline.

The amount of the imidization catalyst used is not particularly limited. Preferably, the molar ratio of the imidization catalyst to the amide groups in the polyamic acid is 10 to 0.01. More preferably, the molar ratio is 5 to 0.5.

When both the dehydrator and the imidization catalyst are used, the molar ratio of the dehydrator to the amide groups in the polyamic acid is preferably 10 to 0.01 and the molar ratio of the imidization catalyst to the amide groups in the polyamic acid is 10 to 0.01. More preferably, the molar ratio of the dehydrator to the amide groups in the polyamic acid is 5 to 0.5, and the molar ratio of the imidization catalyst to the amide groups in the polyamic acid is 5 to 0.5. A reaction retarder such as acetylacetone may be used in combination in these cases.

Additives, such as a heat stabilizer, an antioxidant, a UV absorber, an antistatic agent, a flame retardant, a pigment, a dye, a fatty acid ester, and an organic lubricant (e.g., wax) may be added to the solution. In order to impart lubricity, wear resistance, scratch resistance, and the like to the film surface, inorganic particles such as clay, mica, titanium oxide, calcium carbonate, kaolin, talc, wet or dry silica, colloidal silica, calcium phosphate, calcium hydrogen phosphate, barium sulfate, alumina, or zirconia, or organic particles composed of an acrylate, styrene, or the like may be added to the solution.

In order to prepare a polyamic acid containing the imidization catalyst, the dehydrator, and the additives described above, each component is preferably processed to remove insoluble materials and/or contaminants using, for example, a filter prior to mixing so that the foreign matter and defects in the film can be decreased.

The resulting polyamic acid solution is continuously flow-cast on a support and dried to obtain a gel film. The support may be any support that does not dissolve in the solution resin but withstands the heat required to remove the organic solvent in the polyamic acid solution. In particular, an endless belt composed of connected metal boards or a metal drum is preferred for drying the applied solution. The material of the endless belt or the drum is preferably a metal and more preferably stainless steel. The surface is preferably plated with a metal such as chromium, titanium, nickel, or cobalt so that the adhesion of the solvent to the surface is increased and the dried organic insulating film easily detaches from the surface. The surface of the endless belt of the metal drum is preferably flat but, alternatively, may have numerous irregularities. The irregularities on the endless belt or the metal drum preferably have a diameter of 0.1 μm to 100 μm and a depth of 0.1 μm to 100 μm. By forming irregularities in the metal surface, fine protrusions can be formed on the surface of the organic insulating film. These fine protrusions prevent scratching of the films and improve slidability of the films.

In the present invention, the “gel film” refers to a film that is prepared by heating and drying the polyamic acid solution to an extent that some organic solvent and reaction product (hereinafter referred to as residual components”) remain in the film. In the process of producing the polyimide film, the organic solvent dissolving the polyamic acid solution, an imidization catalyst, a dehydrator, reaction products (water-absorbing components of the dehydrator, water, etc.), and the additives remain as the residual components in the gel film. The content e of the residual components in the gel film is calculated by the following equation:
e=d/c×100 (equation 8)
wherein c (g) is the weight of the gel film after drying and d (g) is the weight of the residual components remaining in the gel film. The content of residual component is preferably 500% or less, more preferably 25% to 250%, and most preferably 30% to 200%.

At the content of residual component exceeding 500%, handling ease during the transfer of the film with the fixed ends through a heating furnace described in step (D) below is degraded, and the amount of the solvent to be removed increases. Thus, the film may undergo significant contraction and it may be difficult to control (b)/(a) within the preferred range. At the content of residual component exceeding 25% or more, (b)/(a) of the coefficient of humidity expansion (b) in the direction perpendicular to the molecular orientation axis to the coefficient of humidity expansion (a) in the direction parallel to the molecular orientation axis, i.e., (b)/(a), can be easily controlled, and the physical properties of the film in the width direction become stable.

The weight c of the gel film after drying and the weight d of the residual components are determined as follows. The weight f of a 100 mm×100 mm gel film is measured, and the gel film is dried in an oven at 350° C. for 20 minutes, cooled to room temperature, and weighed to determine the weight c of the completely dried synthetic resin (i.e., the weight of the gel film after drying). The content d of residual component is determined by the equation d=f−c based on the observed gel film weight f and the weight c of the completely dried synthetic resin.

In the process of producing the gel film, the conditions of heating and drying the solution on the support, for example, the drying temperature, the speed of hot air blown during the drying, the rate of evacuation, and the drying time, are preferably adequately adjusted so that the content of the residual component is within the above-described range. In particular, in the process of producing the polyimide film, the film is preferably heated and dried at a temperature in the range of 50 to 200° C. and more preferably 50 to 180° C. The drying time is preferably 1 to 300 minutes. The drying is preferably performed by controlling the temperature in multiple stages.

The elasticity modulus of the polyimide film of the present invention is preferably high since the molecular orientation of such a film can be easily controlled. The elasticity modulus significantly depends on not only the composition of the polyimide film but also the production process. In order to control the molecular orientation of the polyimide film, the elasticity modulus of the film is preferably 4.0 GPa to 7.0 GPa, wherein the elasticity modulus is defined as the average of the elasticity moduli of the resulting polyimide film observed in the MD direction and the TD direction (the TD direction is perpendicular to the MD direction). A higher elasticity modulus promotes the orientation of the polyimide film. In this invention, the polyimide film preferably exhibits an elasticity modulus within the above-described range. This cab be achieved by adequately selecting the aromatic tetracarboxylic dianhydride and the aromatic diamine used in the polyimide film, by adequately altering the polymerization process after selection of the monomers, or by adequately selecting the production method (the drying method on the belt or the temperature in a tenter furnace) that increases the elasticity modulus.

Step (C)

In step (C), the gel film is peeled from the support, and the ends of the gel film are fixed continuously. In the present invention, In the step the ends of the gel film are held using typical holders used in typical film production systems, such as pin seats and clips, in this step.

The step of fixing the ends of the gel film of the present invention is carried out from a position 52 in FIG. 6(b). At the position 52, end-holding units (pin seats or clips) of a film transferring apparatus described in FIG. 6(b) start to hold the ends of the film.

In at least part of step (D) described below, the film is held while substantially no tension is applied to the film in the TD direction. In order to realize this, in step (C), the gel film may be fixed with the end holding units so that substantially no tension is applied to the gel film in the TD direction. The gel film fixed as such can be continuously transferred to the next step, (D). In detail, in step (C), the film is relaxed while fixing the film ends.

Step (D)

In step (D), the film is transferred through a heating furnace while having its ends fixed.

Step (D) preferably partly includes a step (hereinafter referred to as substep (D-1)) of transferring the fixed film while applying substantially no tension in the film width direction (TD direction). In this manner, a polyimide film having stable physical properties across the entire width can be obtained.

The meaning of that “substantially no tension is applied in the TD direction” is that no tensile force other than the one from the own weight of the film is applied in the TD direction, i.e., no tensile force caused by mechanical handling is applied. In particular, as shown in FIG. 6, and 7, the distance V₁ between the end-fixing units is smaller than the width 61 of the fixed film. A film in such a state is referred to as “film under substantially no tension”. In detail, referring again to FIG. 7, the film is fixed with end-fixing units. The distance between the fixing units in the beginning of the fixing, i.e., the initial distance (hereinafter, this distance is referred to as the fixing start distance between the fixed units) between the end-fixing units, is V₀ in FIG. 6. The film is transferred through a furnace with its ends still fixed. The shortest distance between the fixing units as the film is transferred (hereinafter, this distance is referred to as the minimum distance between the fixed units) is represented by V₁ in FIGS. 6 and 7. In a typical operation, the film is tightly stretched across the fixing units in the beginning of the fixing with a tension applied to the film. Thus, in the beginning, the initial distance V₀ is coincident with the width 61 of the film between the fixing units. Alternatively, the film may be relaxed and then have its ends fixed, as described in step (C) above. In the present invention, as shown in FIG. 7, the minimum distance V₁ between the fixing units is preferably different from and smaller than the width 61 of the film. At the position of the minimum distance between fixing units, the film is relaxed and fixed. In the present invention, preferably, substantially no tension is applied to the film in the TD direction at the entry of the heating furnace of step (D). In this manner, the ratio (b)/(a) of the resulting film described above can be adjusted within the preferred range.

In order to fix and transfer the film so that substantially no tension is applied to the film at the entry of the heating furnace, the ends of the gel film may be fixed in the preceding step (C) so that substantially no tension is applied in the TD direction. In this manner, the film may be directly transferred from step (C) to step (D) (technique 1). Alternatively, after step (C), the distance between the fixed units may be reduced (refer to FIG. 6 where the distance is reduced from V₀ to V₁) and then the film may be transferred to step (D) (technique 2). The technique 2 is simple and is thus preferred.

Note that according to the technique 2, it is preferable to fix the two ends of the gel film by satisfying relationship (equation 9) below:
20.0≧(Y−X)/Y×100>0.00 (equation 9)
wherein X represents the distance V₁ between the fixing units and Y represents the width 61 of the film between the fixing units. In this way, a film having a ratio (b)/(a) adjusted within the preferred range can be easily prepared.

When (Y−X)/Y×100 (this value is sometimes referred to as “TD contraction ratio”) is beyond the above-described range, it becomes difficult to stably control the relaxation of the film and the amount of relaxation may vary relative to the direction of the transfer. In some cases, the film may drop from the fixing units due to relaxing. Thus, wrinkles may be generated in the end portions and stable film production may not be ensured. More preferably, the relationship 15.0≧Y−X)/Y×100>0.00 is satisfied, and most preferably the relationship 10.0≧(Y−X)/Y×100>0.00 is satisfied.

In at least part of step (D), substep (D-1) of fixing and transferring the film while applying substantially no tension to the film in the width direction (TD direction) is performed. In carrying out substep (D-1), the film is preferably fixed so that substantially no tension is applied in the TD direction at the entry of the heating furnace. One approach to achieving this state is to reduce the distance between the fixing units before the film is transferred into the furnace. In other words, the film is fixed by satisfying the relationship below:
Y−X>0.00 (equation 10)
wherein X is the minimum distance V1 between the fixing units and Y is the film width 61 between the fixing units.

Alternatively, the reduction of the distance between the fixed ends may be conducted after completion of the technique 1 or 2, or after the film is transferred into the heating furnace in step (D) (technique 3). In the technique 3, the operation of reducing the distance between the fixing units is preferably performed at 300° C. or less, more preferably 250° C. or less, and most preferably 200° C. or less. If this operation is conducted at a temperature higher than 300° C., the orientation of the film may become difficult to control particularly in the end portions.

During the step, the film is dried and imidization reaction proceeds.

Thus, the film undergoes some degree of shrinking. Even when the film is fixed and transferred under substantially zero tension in the TD direction at the entry of the heating furnace, the film width decreases by shrinkage as the film is heated. Thus, the distance between the fixing units eventually becomes the same as the width of the film between the fixing units. Thus, a wrinkle-free film can be produced.

Step (D) above may include a step (hereinafter referred to as substep (D-2)) of stretching the film in the TD direction. 25 In this invention, substep (D-2) of stretching the film in the TD direction is conducted in a heating furnace after substep (D-1). In substep (D-1), the film is fixed and transferred under substantially no tension in the film width direction (TD direction). As the film is heated in the heating furnace, the film undergoes some degree of shrinking which eliminate the relaxation of the film. This film is then stretched in the TD direction. The amount of stretch (here, this is referred to as “expansion ratio” for sake of simplicity) preferably satisfies the equation (11):
40.0≧(C−B)/B×100≧0.00 (equation 11)
wherein B is the distance V₁ between the fixed units (refer to FIG. 6(a)) in the TD direction and C is the distance V₂ or V₃ between the fixed ends after the film is stretched in the TD direction in the furnace (refer to FIG. 6(a)).

When (C−B)/B×100 (sometimes referred to as “TD expansion ratio”) is beyond the above-described range, it may become difficult to control the molecular orientation axis of the film in the MD direction. More preferably, the relationship 30.0≧(C−B)/B×100≧0.00 is satisfied, and most preferably the relationship 20.0≧(C−B)/B×100≧0.00 is satisfied. If necessary, reduction of the distance may be performed after substep (D-2) or the film width may be further increased by stretching. The TD contraction ratio and the TD expansion ratio may be selected as desired.

The temperature of substep (D-2) is 300° C. to 500° C. and preferably 350° C. to 480° C. so that the elasticity modulus of the polyimide film is decreased and the film is easy to stretch. Within these temperatures, the film may sometimes become excessively soft and loosened during the transfer through the furnace. In such a case, the temperature is preferably adjusted outside the above-described ranges.

In this invention, the contraction in substep (D-1), the stretching in substep (D-2), the film tension in the MD direction during the transfer, the content of the residual component of the gel film, and heating temperature may be adequately adjusted to produce a film having the ratio (b)/(a) controlled within a predetermined range. the ratio (b)/(a) is represented by the coefficient of humidity expansion (a) in the direction parallel to the molecular orientation axis and the coefficient of humidity expansion (b) in the direction perpendicular to the molecular orientation axis. Although the heating temperature and heating time of the film completely differ depending on whether chemical imidization or thermal imidization is conducted, a target film can still be obtained by thermal imidization by controlling the process as described above.

A known heating furnace may be used as the heating furnace used in the invention. Preferable examples of the heating furnace include (1) a hot blast furnace in which hot air of 60° C. or higher is blasted toward the entire film from above and/or below the film and (2) a far infrared furnace equipped with a far infrared ray generator for baking the film by the irradiation with far infrared rays.

The conditions of transferring the film through the heating furnace are not particularly limited. Preferably, the film is baked by increasing the temperature stepwise. Thus, a plurality of heating furnaces is preferably used to comply with the increase in temperature. The plurality of heating furnaces is not particularly limited and may be hot blast furnaces, far infrared furnaces, or a combination of blast furnaces and far infrared furnaces.

For example, both hot air furnaces and far infrared furnaces may be combined to form a single heating furnace line that can increase the temperature stepwise. The number of the heating furnaces and the temperatures of the respective furnaces may be adequately adjusted according to the baking conditions. In the present invention, the heating temperature (initial heating temperature) of the furnace into which the gel film with fixed ends is transferred first is preferably 300° C. or less, more preferably 60° C. to 250° C., and most preferably 100° C. to 200° C. In this temperature range, the ratio of the coefficient of humidity expansion (b) in the direction perpendicular to the molecular orientation as to the coefficient of humidity expansion (a) in the direction parallel to the molecular orientation axis, i.e., the ratio (b)/(a), can be easily controlled across the entire width of the resulting polyimide film.

In detail, the film is preferably transferred through two or more heating furnaces, the first one of which having a temperature of 300° C. or less (refer to a furnace 41 in FIG. 6(b)). In particular, the boiling point of the solvent contained in the gel film should be investigated, and the film is preferably controlled at a temperature 100° C. or less higher than the boiling point of the solvent.

The temperature of the second furnace (a furnace 42 in FIG. 6(b)) is preferably set to a temperature 50° C. to 300° C. higher than the temperature of the first furnace (a furnace 41 in FIG. 6(b)). In particular, the temperature of the second furnace is preferably 60° C. to 250° C. higher than the temperature of the first furnace from the standpoint of controlling the ratio (b)/(a) of the polyimide film. The temperatures of the subsequent furnaces are preferably the same as those employed in typical polyimide film production. When the temperature of the first furnace (a furnace 41 in FIG. 6(b)) is 60° C. or lower, the temperature of the second furnace (a furnace 42 in FIG. 6(b)) is preferably adjusted to 100° C. to 250° C. In this manner, a polyimide film having a controlled ratio (b)/(a) can be obtained. The initial temperature and the temperature of the second furnace are thus preferably adjusted as above.

It is possible to produce a polyimide film at a heating temperature less than 100° C. However, the film does not easily dry at such a temperature. Thus, when the temperature of the first furnace is less than 100° C., the temperature of the second furnace is preferably adjusted to 100° C. to 250° C.

The heating temperatures of the furnaces that follow the first and second furnaces (the furnaces that follow a third furnace) are preferably adjusted stepwise to 200° C. to about 600° C. Since the imidization would not be completed at a low maximum baking temperature, the film is preferably thoroughly heated stepwise.

A specific description is provided below using a stepwise heating furnace system as an example. Referring to FIGS. 6(a) and 6(b), a stepwise heating furnace system 40 is constituted from five heating furnaces 41 to 45. A first furnace 41, a second furnace 42, a third furnace 43, a fourth furnace 44, and a fifth furnace 45 are disposed in this order along the machining direction of the polyimide film 51 (the MD direction: the D₁ direction). FIG. 6(a) is a schematic diagram of the stepwise heating furnace system 40 viewed from the top of the system. FIG. 6(b) is a side view of the stepwise heating furnace system 40 and a winding device 46 for winding the polyimide film. As shown in FIG. 6(a), the gel film 50 is tightly stretched between a pair of holding units 52 at the ends of the film in the width direction (TD direction) and is transferred into the first furnace 40.

The tension applied in the MD direction to the gel film transferred into the furnace is calculated as the tension applied per meter of the film. The tension is preferably 1 to 20 kg/m, more preferably 1 to 15 kg/m, and most preferably 1 to 10 kg/m. At a tension less than 1 kg/m, stable transfer of the film is difficult, and stable production of the film by holding the film may be difficult. At a tension exceeding 20 kg/m, control of the molecular orientation in the MD direction at the ends of the film may become difficult.

Examples of the device for applying tension to the gel film transferred into the furnace and controlling the tension include loading rollers that apply loads to the gel film, rollers that apply variable loads by adjusting the rotating speed, and nip rollers for controlling the tension by clamping the gel film with two rollers.

Optional Step (E)

In this invention, the process of producing the polyamide film may include steps other than steps (A) to (D) described above. For example, as shown in FIG. 6(b), a step of winding the film that has passed through the heating furnace may be performed with a winding device 46. A device for applying a varnish of various types or a device for surface treatment may be provided to the system.

If necessary, the polyimide film may be processed, e.g., heated, molded, surface-treated (plasma treated or corona-discharge treated), laminated, coated, printed, embossed, or etched.

Laminate Incorporating Polyimide Film of the Invention

The applications of the polyimide film of the present invention are not particularly limited. The polyimide film is suitable for electric/electronic device substrate applications, such as flexible printed wiring boards, TAB tapes, solar cell substrates, high-density recording medium applications, and magnetic recording applications.

The polyimide film of the present invention may be a single-layer film of polyimide or may be combined with other layers to form a laminate. For example, a polymer layer may be formed by application on at least one surface of the polyimide film. For example, a layer of a thermoplastic polyimide (a polyimide resin having a glass transition temperature of 400° C. or less), a polyester, a polyolefin, a polyamide, a polyvinylidene chloride, or an acrylic polymer may be formed on the film either directly or with an epoxy or acrylic adhesive layer therebetween.

Preferable examples of the process for producing the laminate from the gel film includes (1) a process of immersing the gel film in a solution of another resin and then drying the resulting gel film by heating in a tenter furnace to produce a laminated film; (2) a process of applying a solution or another resin onto a surface of the gel film with a coater and drying the applied solution under heating to produce a laminated film; and (3) a process of applying a solution of another resin onto the gel film using a sprayer and drying the applied solution under heating to produce a laminated film. A process of applying again a solution of another resin (preferably a polyamic acid solution which is the precursor of a thermoplastic polyimide or a thermoplastic polyimide solution) onto the surface of the molded polyimide film and drying the applied solution under heating to produce a laminate may be also be employed. As the lamination method, those described in (1) to (3) above are preferred.

In the process of producing a polyimide film of the present invention, it is possible to flow-cast one or more layers of the polyamic acid solution or the polyimide solution simultaneously or sequentially on the support.

The laminate may be a polyimide film having an adhesive layer. In such a case, a protective material for protecting the adhesive layer may be laminated thereon.

Examples of the process of producing a metal-clad laminate composed of a polyimide film laminated with a metal are as follows:

(1) A process of bonding a metal foil onto at least one surface of the polyimide film by thermocompression with an adhesive layer between the film and the metal foil. Examples thereof include a press method, a double belt method, and a hot calendar roll method. Preferable examples of the adhesive include thermoplastic polyimide resins, thermoplastic polyimide resin adhesives, acrylic adhesives, and epoxy adhesives. Examples of the metal foil include foils having a thickness of at least 0.1 μm composed of copper, aluminum, gold, silver, nickel, chromium, and an alloy thereof.

(2) A process of directly depositing a metal onto at least one surface of the polyimide film. Preferable examples of the process include a thermal evaporation deposition technique of evaporating a metal in a furnace by heating, an electron beam deposition technique of heating and evaporating the metal by an electron beam (EB technique), and a sputtering deposition technique of evaporating the metal with plasma. The metal used may be any. For example, the metal may be copper, gold, silver, manganese, nickel, chromium, titanium, tin, cobalt, indium, molybdenum, or the like. Two or more of these metals may be simultaneously evaporated to deposit a metal alloy on the surface of the polyamide film. For example, nickel and chromium may be simultaneously deposited to form a nickel/chromium alloy, or indium and tin may be simultaneously deposited in the presence of oxygen to deposit an ITO film. Two or more of the above-described metals may be deposited to form a metal-clad laminate.

(3) A process of electroplating or electroless-plating the metal-clad laminate produced by the process (2) to increase the thickness of the metal layer. Electroplating is a technique of immersing a workpiece in a solution dissolving a metal to be plated and supplying electricity between the workpiece serving as an electrode and a counter electrode of a metal for plating so that the workpiece is plated with the metal. The electroplating is not limited to this, and any known electroplating technique may be used to form the laminate. Another example of the method for increasing the thickness of the metal layer includes immersing a polyimide film having a metal layer onto which an electroless plating catalyst is applied in an electroless-plating bath dissolving a target metal so as to deposit the metal on the film. The electroless plating technique is not limited to this, and any known electroless plating technique may be employed to form a laminate.

(4) A process of depositing a thin layer of a metal by electroless plating. The electroless plating technique may be any as long as it includes applying an electroless plating catalyst metal onto the surface of the polyimide film and subsequently immersing the resulting polyimide film in a metal bath for electroless plating to deposit the metal. The electroless plating technique is not limited to this, and any known electroless plating technique may be used to form the laminate.

(5) A process of increasing the thickness of the metal layer of the metal-clad laminate produced by the process (4) by electroplating or electroless plating.

The polyimide-metal laminates produced by the processes described in (1) to (5) above may each include a protective material layer for protecting the metal layer.

The metal layer of the metal-clad laminate produced as such may be processed, e.g., may be etched after formation of an etching mask on the film surface, to form leads. A polyimide film having metal leads thereon can be produced as a result.

The laminate of the present invention is not particularly limited as long as it includes the polyimide film of the present invention. Moreover, in the present invention, although representative examples of the process for making metal-clad laminates are described in detail above, the process of producing a metal-clad laminate (e.g., an FPC, a TAB, a high-density recording medium, a magnetic recording medium, a metal-clad laminate for electric/electronic devices) including the polyimide film as the base film is not limited to those described above. Various techniques conceivable by persons skilled in the art may be used to deposit the metal layer.

### EXAMPLES

The present invention will now be described by way of specific examples, but is not limited by these examples. In particular, examples of the process of producing the polyimide film will be described below.

### Example 1

Production of Polyimide Film

In this example, 45 mol % of 4,4-diaminodiphenyl ether (ODA), 55 mol % of p-phenylenediamine (p-PDA), 45 mol % of p-phenylene bis(trimellitic monoester anhydride) (TMHQ), and 55 mol % of pyromellitic dianhydride (PMDA) were combined and polymerized in N,N-dimethylformamide (DMF) to prepare a polyamic acid solution. To the polyamic acid solution, 2.0 equivalents of acetic anhydride and 1.0 equivalent of isoquinoline relative to amic acid were added, and the resulting solution was cast onto an endless belt so that the layer of the applied solution has a width of 1,100 mm and a final thickness of 20 μm. The applied solution was dried with hot air at 100° C. to 150° C. for 2 minutes, and a self-supporting gel film having a residual component content of 54 wt % was obtained as a result. The gel film was peeled off from the belt, and the two ends of the gel film in the width direction were fixed onto pin seats for continuous transfer of the film. The distance between the pin seats was 1,000 mm, and the film was tightly stretched without relaxation and fixed. The fixed gel film was passed through a first heating furnace (172° C.), a second heating furnace (310° C.), a third heating furnace (400° C.), and a fourth heating furnace (513° C.) to form a polyimide film in a stepwise manner. The polyimide film was transferred while being contracted and/or expanded in the TD direction to adjust the TD contraction ratio to 4.30 and the TD expansion ratio to 2.10. The step of reducing the distance between the pin seats so that substantially no tension is applied to the polyimide film in the TD direction was completed before the film was introduced to the furnace. The step of increasing the distance between the pin seats was performed in the third heating furnace. The manufacturing conditions are shown in Table 1.

Synthesis of Thermoplastic Polyimide Precursor

To an organic solvent DMF for polymerization, 100 mol % of bis[4-(4-aminophenoxy)phenyl] sulfone (BAPS), 90 mol % of 3,3′,4,4′-biphenyltetracarboxylic dianhydride (BPDA), and 10 mol % of 3,3′,4,4′-ethylene glycol benzoate tetracarboxylic dianhydride (TMEG) were added and polymerized under stirring to synthesize a polyamic acid solution, which is the precursor of the thermoplastic polyimide. The solid content of the polyamic acid solution was 20 wt %.

Moefficient of Humidity Expansion and Coefficient of Humidity Expansion Ratio

From a sample for measuring the molecular orientation angle described below, test pieces (10 mm×20 mm) were respectively cut out in a direction parallel to the molecular orientation axis and in a direction perpendicular to the molecular orientation axis, as shown in FIG. 2.

By varying the humidity as shown in FIG. 3, the change in humidity and the elongation ratio of each polyimide film test piece were measured simultaneously to determine the humidity elongation ratio based on the equation below:
Humidity elongation ratio={amount (d) of elongation by moisture absorption/(initial length of sample)}/change (b) in humidity

Based on the calculated humidity elongation ratio based on the above-described equation, the coefficient of humidity expansion was calculated based on the following equation:
Coefficient of humidity expansion={Humidity elongation ratio}×10⁶

Here, the change b in humidity was set to 40 RH % (measurement was carried out under such condition that lower humidity was 40 RH % and higher humidity was 80 RH %). The amount (d) of elongation of the polyimide film was measured under 3 g load.

Molecular Orientation Angle

The molecular orientation angles in the two end portions and at the center of the polyimide film were determined with molecular orientation analyzer MOA2012. The molecular orientation angular difference was calculated as the difference between the observed maximum orientation angle and the observed minimum orientation angle from a equation:
maximum−minimum.
Preparation of Flexible Metal-Clad Laminate

The polyimide film was preliminarily treated by conducting plasma discharge at an output of 280 W/m2 in an Ar:He:N2=7:2:1 (volume ratio) mixed gas stream on the film surface. The above-described thermoplastic polyimide precursor was diluted with DMF to a solid content of 10 wt %, and the diluted thermoplastic polyimide precursor was applied on the both surfaces of the polyimide film over the entire width so that the final thickness of the thermoplastic polyimide layer (adhesive layer) at one side is 4 μm, followed by one minute of heating at 140° C. The film was then passed through a heating furnace having an atmospheric temperature of 390° C. in 20 seconds to conduct thermal imidization. A polyimide film with thermoplastic polyimide layers thereon was obtained as a result.

An 18 μm rolled copper foil (BHY-22B-T, produced by Japan Energy Corporation) was disposed on each surface of this polyimide film, and a protective material (Apical 125NPI produced by Kaneka Corporation) was applied on each copper foil on the surface to form a composite. The composite was continuously thermally laminated with a hot roll laminator at a lamination temperature of 380° C., a lamination pressure of 196 N/cm (20 kgf/cm), a lamination speed of 1.5 m/min while applying 0.4 N/cm of tension to the polyimide film to prepare a flexible metal-clad laminate of the present invention.

Ratio of Change in Dimensions

In accordance with the sampling method shown in FIG. 8, samples of an adequate size were taken from the two end portions and the center portion of the flexible metal-clad laminate. The dimensions of each sample was measured at the following four points, as shown in FIG. 9: (1) the dimension in the machining direction of the film (the MD direction: a dimension 81 in FIG. 9), (2) the dimension in a direction perpendicular to the machining direction (the TD direction : dimension 80 in FIG. 9), (3) the dimension at 45° with respect to the film machining direction (the R direction, a dimension 82 in FIG. 9), and (4) the dimension at −45° with respect to the film machining direction (the L direction : a dimension 83 in FIG. 9;.

The changes in dimensions were measured according to JIS C6481 as follows: First, four holes were formed in each sample of the flexible metal-clad laminate, and the distances between the holes were respectively measured. Next, the sample was etched to remove the metal. In detail, a hydrochloric acid solution (concentration was 30% or higher) of ferric chloride produced by Harima Kagaku Kogyo K.K. was heated to 30° C. with a heater, and the heated solution was sprayed from above and below the film to expose the both surfaces of the film to the solution to conduct etching. The time of contact between the ferric chloride solution and the metal-clad laminate was set to within 10 minutes. The time was adjusted according to the etching rate to conduct etching. After the etching, the film was washed and dried by blowing off the droplets. A film with a copper layer removed was thus produced. This film was left to stand in a thermostatic chamber for 24 hours at 20° C. and 60% RH. Subsequently, the distances between the four holes were measured as before the etching. The ratio of change in dimensions before and after the etching was calculated by the equation below:
Ratio of change in dimension (%)={(D2−D1)/D1}×100
wherein D1 is the observed distance between the holes before the removal of the metal foil and D2 is the observed distance between the holes after the removal of the metal foil.

The ratio of change in dimensions was calculated for each of (1) to (4) described above, The observed results of (1) and (2) were each determined as an average value of two sides of the test piece.

The observed physical properties of the film are shown in Table 2.

### Example 2

A polyimide film was prepared as in EXAMPLE 1 except that the distance between the pin seats was set to 1,020 mm, the TD contraction ratio was set to 4.30, and the TD expansion ratio was set to 4.30.

The conditions of manufacture are shown in Table 1.

The physical properties of the resulting polyimide film were determined as in EXAMPLE 1. The results showed that the coefficient of humidity expansion ratio b/a of the coefficient of humidity expansions across the entire film width was within 1.01 to 2.00, that the difference between maximum and minimum coefficient of humidity expansions was 0.30 or less, and that the molecular orientation angle was within 0±20°. The physical properties of the film are shown in Table 2.

### Example 3

A polyimide film was prepared as in EXAMPLE 1 except that the residual component content of the gel film was set to 60 wt %, the distance between the pin seats was set to 1,060 mm, the TD contraction ratio was set to 3.70, the TD expansion ratio was set to 0.00, and the temperatures inside the furnaces were respectively set to 132° C., 255° C., 350° C., 440° C., and 512° C. The conditions of manufacture are shown in Table 1.

The physical properties of the resulting polyimide film were evaluated as in EXAMPLE 1. The results showed that the coefficient of humidity expansion ratio b/a of the coefficient of humidity expansions across the entire film width was within 1.01 to 2.00, that the difference between maximum and minimum coefficient of humidity expansion ratios was 0.30 or less, and that the molecular orientation angle was within 0±20°. The physical properties of the film are shown in Table 2.

### Example 4

A polyimide film was prepared as in EXAMPLE 1 except that the content of residual component of the gel film was set to 60 wt %, the distance between the pin seats was set to 1,070 mm, the TD contraction ratio was set to 2.20, the TD expansion ratio was set to 0.00, and the temperatures inside the furnaces were respectively set to 135° C., 255° C., 340° C., 430° C., and 510° C. The conditions of manufacture are shown in Table 1.

The physical properties of the resulting polyimide film were evaluated as in EXAMPLE 1. The results showed that the coefficient of humidity expansion ratio b/a of the coefficient of humidity expansions across the entire film width was within 1.01 to 2.00, that the difference between maximum and minimum coefficient of humidity expansions was 0.30 or less, and that the molecular orientation angle was within 0±20°. The physical properties of the film are shown in Table 2.

### Example 5

A polyimide film was prepared as in EXAMPLE 1 except that the content of the residual component of the gel film was set to 52 wt %, the distance between the pin seats was set to 1,060 mm, the TD contraction ratio was set to 4.20, the TB expansion ratio was set to 0.00, and the temperatures inside the furnaces were respectively set to 155° C., 300° C., 450° C., and 510C. The conditions of manufacture are shown in Table 1.

The physical properties of the resulting polyamide film were evaluated as in EXAMPLE 1. The results showed that the coefficient of humidity expansion ratio b/a of the coefficient of humidity expansions across the entire film width was within 1.01 to 2.00, that the difference between maximum and minimum coefficient of humidity expansions was 0.30 or less, and that the molecular orientation angle was within 0±20°. The physical properties of the film are shown in Table 2.

### Example 6

A polyimide film was prepared as in EXAMPLE 1 except that the content of the residual component of the gel film was set to 71 wt %, the distance between the pin seats was set to 1,060 mm, the TD contraction ratio was set to 3.10, the TD expansion ratio was set to 0.00, and the temperatures inside the furnaces were respectively set to 170° C., 300° C., 450° C., and 515° C. The conditions of manufacture are shown in Table 1.

The physical properties of the resulting polyimide film were evaluated as in EXAMPLE 1. The results showed that the coefficient of humidity expansion ratio b/a of the coefficient of humidity expansions across the entire film width was within 1.01 to 2.00, that the difference between maximum and minimum coefficient of humidity expansions was 0.30 or less, and that the molecular orientation angle was within 0±20°. The physical properties of the film are shown in Table 2.

### Example 7

A polyimide film was prepared as in EXAMPLE 1 except that the content of the residual component of the gel film was set to 68 wt %, the distance between the pin seats was set to 1,060 mm, the TD contraction ratio was set to 5.20, the TD expansion ratio was set to 0.00, and the temperatures inside the furnaces were respectively set to 1650° C., 300° C., 450° C., and 515° C. The conditions of manufacture are shown in Table 1.

The physical properties of the resulting polyimide film were evaluated as in EXAMPLE 1. The results showed that the coefficient of humidity expansion ratio b/a of the coefficient of humidity expansions across the entire fin width was within 1.01 to 2.00, that the difference between maximum and minimum coefficient of humidity expansions was 0.30 or less, and that the molecular orientation angle was within 0±20°. The physical properties of the film are shown in Table 2.

### Comparative Example 1

A polyimide film was prepared as in EXAMPLE 1 except that the TD contraction ratio was set to 0.00 and the TD expansion ratio was set to 0.00. The conditions of manufacture are shown in Table 3.

The physical properties of the resulting polyimide Elm were measured as in EXAMPLE 1. The results are shown in Table 4.

TABLE 1

| | | | | | Distance | Minimum | | | |
|---|---|---|---|---|---|---|---|---|---|
| | | Residual | In-furnace | | b/w fixing | distance | | | |
| | | component | initial | Elongation | units at | between | | TD | TD |
| | | content | temperature | temperature | the time of | the fixing | Y-X | contraction | expansion |
| | | (%) | (° C.) | (° C.) | fixing (mm) | units (mm) | (mm) | ratio | ratio |
| EXAMPLE 1 | End | 54 | 172 | 400 | 1,000 | 957 | 43 | 4.30 | 2.10 |
| | Center | | | | | | | | |
| | End | | | | | | | | |
| EXAMPLE 2 | End | 54 | 172 | 400 | 1,020 | 976 | 44 | 4.30 | 4.30 |
| | Center | | | | | | | | |
| | End | | | | | | | | |
| EXAMPLE 3 | End | 60 | 132 | — | 1,060 | 1,021 | 39 | 3.70 | 0.00 |
| | Center | | | | | | | | |
| | End | | | | | | | | |
| EXAMPLE 4 | End | 60 | 135 | — | 1,070 | 1,046 | 24 | 2.20 | 0.00 |
| | Center | | | | | | | | |
| | End | | | | | | | | |
| EXAMPLE 5 | End | 52 | 155 | — | 1,060 | 1,015 | 45 | 4.20 | 0.00 |
| | Center | | | | | | | | |
| | End | | | | | | | | |
| EXAMPLE 6 | End | 71 | 170 | — | 1,060 | 1,027 | 33 | 3.10 | 0.00 |
| | Center | | | | | | | | |
| | End | | | | | | | | |
| EXAMPLE 7 | End | 68 | 165 | — | 1,060 | 1,005 | 55 | 5.20 | 0.00 |
| | Center | | | | | | | | |
| | End | | | | | | | | |

TABLE 2

| | | | | coefficient of humidity | | | | | | | |
|---|---|---|---|---|---|---|---|---|---|---|---|
| | | | | expansion (ppm/° C.) | | | | | | | |
| | | | Molecular | Parallel to | Perpendicular | coefficient | | | | | |
| | | Molecular | orientation | molecular | to molecular | of humidity | | Ratio of change in dimensions | | | |
| | | orientation | angular | orientation | orientation | expansion | Max- | after etching (%) | | | |
| | | angle | difference | axis | axis | ratio | Min | MD | TD | R | L |
| EXAMPLE 1 | End | 1 | 7 | 6.9 | 8.4 | 1.22 | 0.23 | −0.02 | −0.03 | −0.01 | −0.05 |
| | Center | −2 | | 7.9 | 8.4 | 1.06 | | −0.02 | −0.02 | −0.02 | −0.02 |
| | End | 5 | | 6.5 | 8.4 | 1.29 | | −0.02 | −0.03 | −0.01 | −0.05 |
| EXAMPLE 2 | End | −6 | 16 | 6.5 | 10.8 | 1.66 | 0.05 | −0.04 | −0.04 | −0.03 | −0.03 |
| | Center | −5 | | 6.8 | 11.1 | 1.63 | | −0.03 | −0.07 | −0.04 | −0.05 |
| | End | 10 | | 6.4 | 10.3 | 1.61 | | −0.05 | −0.04 | −0.05 | −0.03 |
| EXAMPLE 3 | End | −3 | 9 | 6.8 | 9.6 | 1.41 | 0.01 | −0.04 | −0.04 | −0.03 | −0.03 |
| | Center | 1 | | 7.0 | 9.8 | 1.40 | | −0.03 | −0.03 | −0.04 | −0.02 |
| | End | 6 | | 6.9 | 9.7 | 1.41 | | −0.04 | −0.04 | −0.02 | −0.02 |
| EXAMPLE 4 | End | −7 | 13 | 7.1 | 10.4 | 1.46 | 0.01 | −0.04 | −0.03 | −0.03 | −0.04 |
| | Center | 2 | | 6.9 | 10.2 | 1.48 | | −0.03 | 0.00 | −0.03 | −0.03 |
| | End | 6 | | 7.0 | 10.3 | 1.47 | | −0.04 | −0.03 | −0.02 | −0.03 |
| EXAMPLE 5 | End | −4 | 16 | 4.5 | 7.8 | 1.73 | 0.06 | 0.02 | −0.05 | −0.01 | 0.00 |
| | Center | −7 | | 4.4 | 7.9 | 1.80 | | 0.03 | −0.06 | −0.03 | 0.01 |
| | End | 9 | | 4.2 | 7.5 | 1.79 | | 0.04 | −0.05 | −0.02 | 0.02 |
| EXAMPLE 6 | End | −14 | 24 | 6.2 | 9.1 | 1.47 | 0.14 | −0.02 | −0.04 | −0.04 | −0.03 |
| | Center | 6 | | 6.5 | 9.6 | 1.48 | | −0.03 | −0.05 | −0.03 | −0.04 |
| | End | 10 | | 5.9 | 9.5 | 1.61 | | −0.03 | −0.04 | −0.02 | −0.02 |
| EXAMPLE 7 | End | −13 | 23 | 5.9 | 8.5 | 1.44 | 0.10 | 0.02 | −0.03 | 0.00 | 0.00 |
| | Center | 9 | | 6.3 | 8.8 | 1.40 | | 0.03 | −0.03 | −0.02 | 0.02 |
| | End | 10 | | 6.5 | 8.7 | 1.34 | | 0.05 | −0.02 | −0.02 | 0.02 |

TABLE 3

| | | | | | Distance | Minimum | | | |
|---|---|---|---|---|---|---|---|---|---|
| | | Residual | In-furnace | | b/w fixing | distance | | | |
| | | component | initial | Elongation | units at | between | | TD | TD |
| | | content | temperature | temperature | the time of | the fixing | Y-X | contraction | expansion |
| | | (%) | (° C.) | (° C.) | fixing (mm) | units (mm) | (mm) | ratio | ratio |
| COMPARATIVE | End | 54 | 172 | — | 1,060 | 1,060 | 0 | 0.00 | 0.00 |
| EXAMPLE 1 | Center | | | | | | | | |
| | End | | | | | | | | |

TABLE 4

| | | | | coefficient of humidity | | | | | | | |
|---|---|---|---|---|---|---|---|---|---|---|---|
| | | | | expansion (ppm/° C.) | | | | | | | |
| | | | Molecular | Parallel to | Perpendicular | coefficient | | | | | |
| | | Molecular | orientation | molecular | to molecular | of humidity | | Ratio of change in dimensions | | | |
| | | orientation | angular | orientation | orientation | expansion | Max- | after etching (%) | | | |
| | | angle | difference | axis | axis | ratio | Min | MD | TD | R | L |
| COMPARATIVE | End | −45 | 90 | 5.1 | 8.4 | 1.65 | 0.83 | −0.04 | 0.03 | 0.10 | −0.12 |
| EXAMPLE 1 | Center | −6 | | 6.3 | 7.8 | 1.24 | | −0.08 | −0.01 | 0.00 | 0.03 |
| | End | 45 | | 4.6 | 9.5 | 2.07 | | −0.11 | 0.04 | −0.10 | 0.08 |

### BRIEF DESCRIPTION OF THE DRAWINGS

FIG. 1 shows a method of taking samples for measuring molecular orientation angles and a molecular orientation axis.

FIG. 2 shows a method of sampling test pieces for measuring the coefficient of humidity expansion.

FIG. 3 is shows results for determining the coefficient of humidity expansion.

FIG. 4 is a schematic diagram of a measurement system of the coefficient of humidity expansion.

FIG. 5 is a diagram for explaining the molecular orientation axis and the molecular orientation angle of the film.

FIG. 6s are schematic diagrams showing the transfer of the film;

FIG. 7 is a schematic diagram showing the state of the fixed film.

FIG. 8 is a schematic diagram showing positions from which test pieces are taken.

FIG. 9 is a schematic diagram explaining positions at which the changes in dimensions are measured.

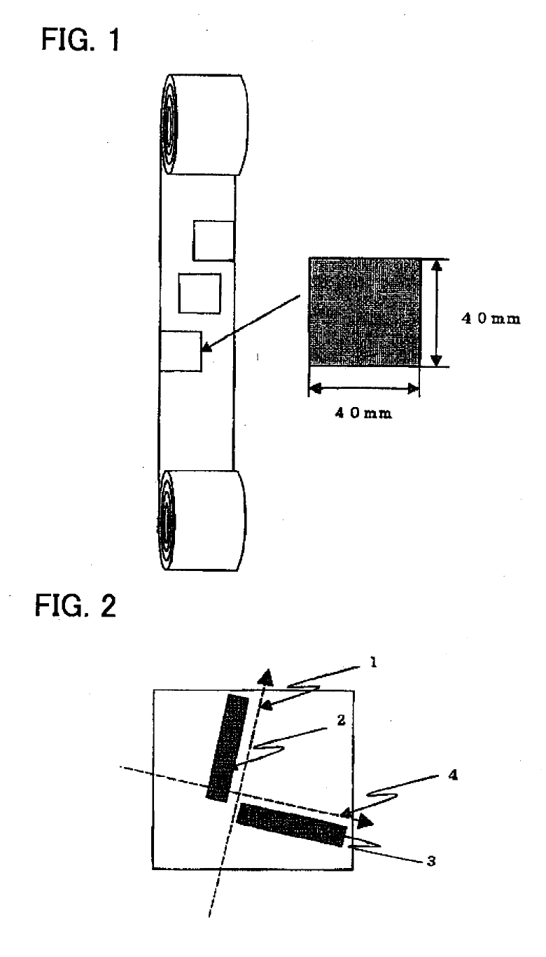

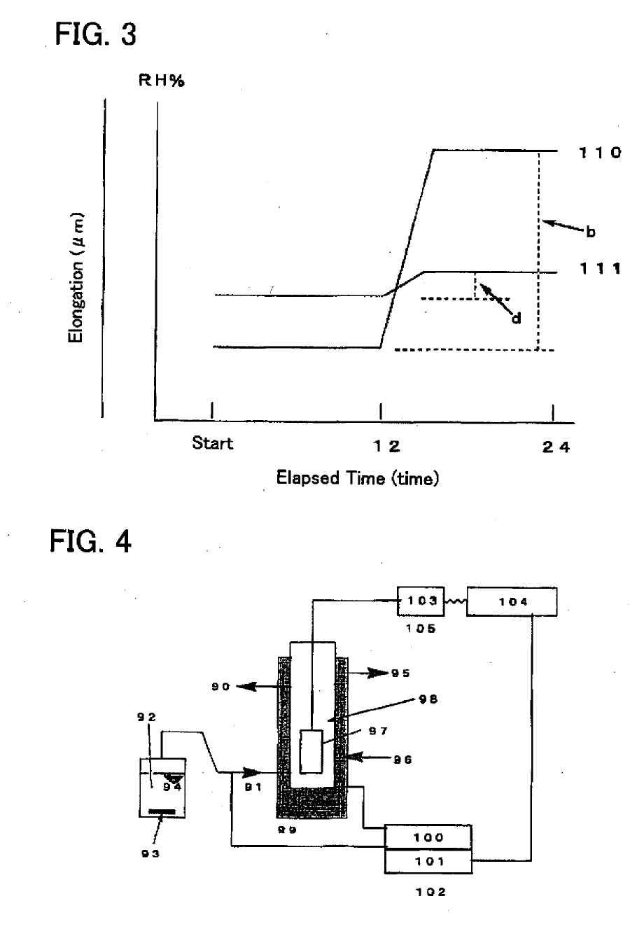

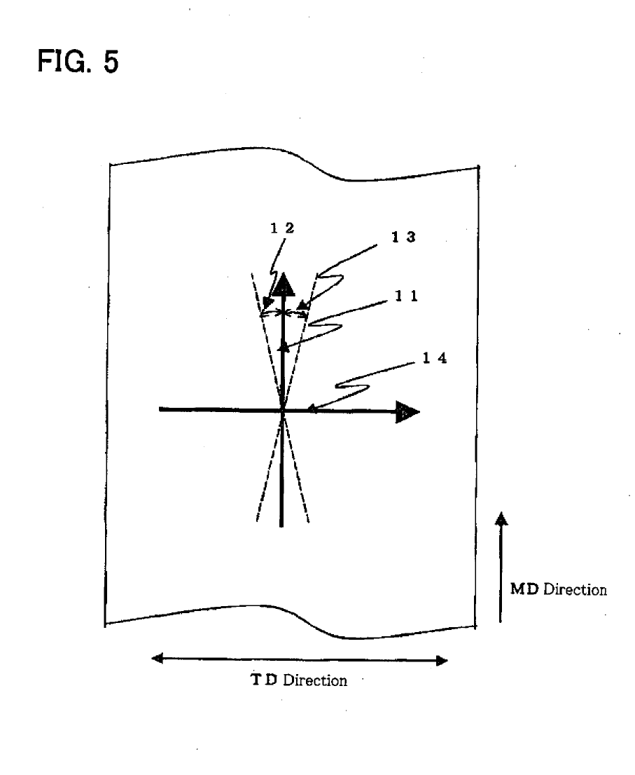

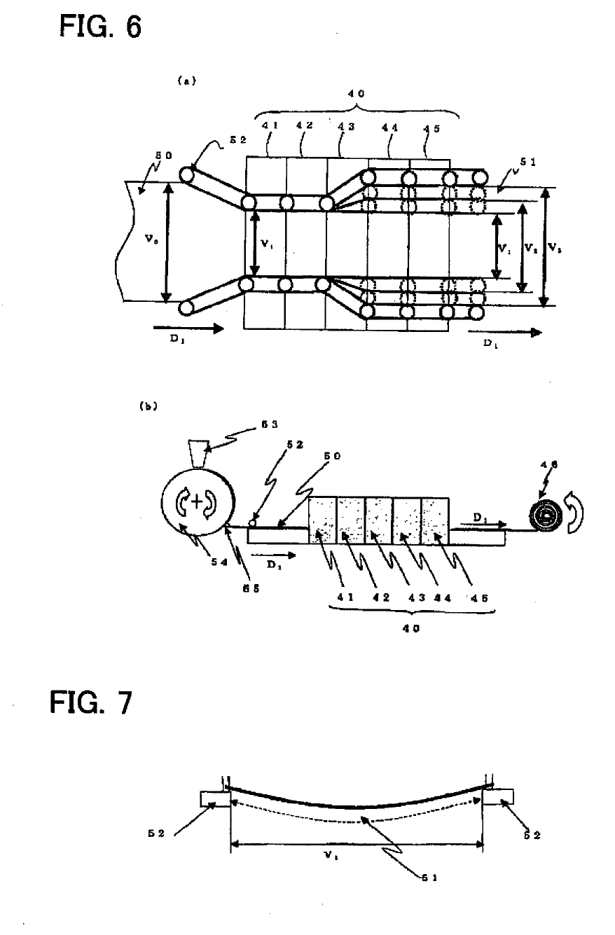

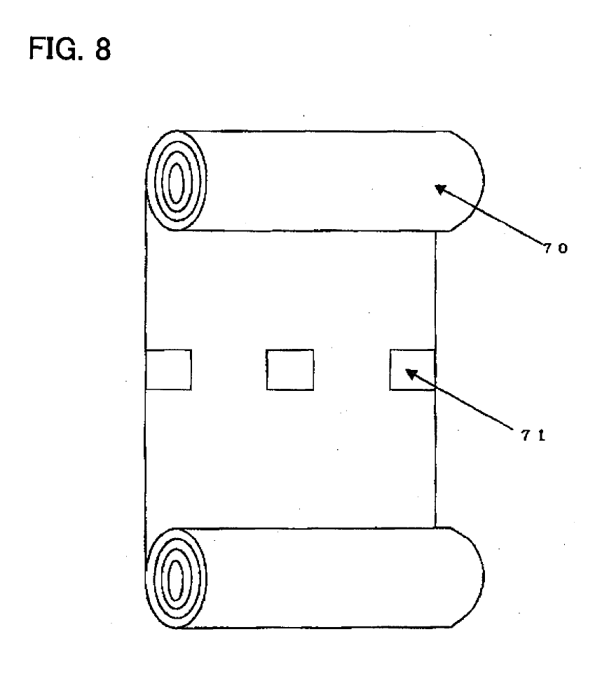

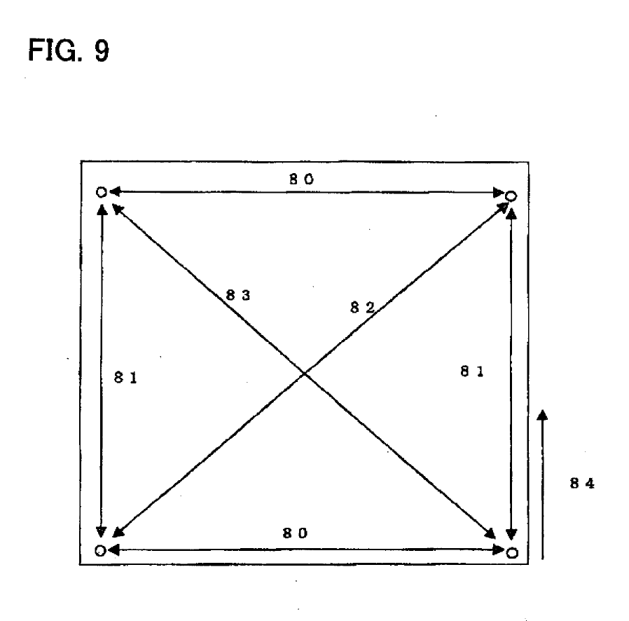

### REFERENCE NUMERAL

1 Molecular orientation axis
2 Specimen (in directions parallel to the molecular orientation axis)
3 Specimen (in directions perpendicular to the molecular orientation axis)
4 Direction perpendicular to the molecular orientation axis
11 MD direction (a machining direction of a film)
12 Plus molecular orientation angle
13 Minus molecular orientation angle
14 TD direction (a direction perpendicular to the machining direction of a film)
40 Stepwise heating furnace system
41 First furnace
42 Second furnace
43 Third furnace
44 Fourth furnace
45 Fifth furnace
46 Step of winding with a winding device (winding device for winding the polyimide film)
50 Gel film
51 Polyimide film
52 Holding unit for gel film
53 Die for applying polyamic acid solution
54 Substrate for applying polyamic acid solution
55 Dimension for peeling gel film
61 Width of the film between the fixing units
70 flexible metal-clad laminate (FPC)
71 Sample for measuring a ratio of Change in Dimensions
80 Dimension for measuring in a direction perpendicular to the machining direction of a film (TD direction)
81 Dimension for measuring in a direction to the machining direction of a film (MD direction)
82 Direction at 45° with respect to a film machining direction (R direction)
83 Direction at −45° with respect to a film machining direction (L direction)
84 Direction with respect to a film machining direction (MD direction)
90 Outlet of vapor
91 Inlet of vapor
92 Nitrogen bubbler
93 Heater for generating water vapor
94 Water
95 Outlet of hot water
96 Inlet of hot water (Hot water bath)
97 Sample
98 Sample chamber
99 Thermostatic chamber (50° C.)
100 Humidity sensor
101 Humidity converter
102 Humidity control unit
103 Detector
104 Recording unit
105 Device for measuring elongation
110 Change in humidity
111 Length of elongation

### INDUSTRIAL APPLICABILITY

When this polyimide film is used as the base film of an FPC, the changes in dimensions that occur during the production process can be decreased, and the ratio of change in dimensions across the entire width of the polyimide film can be reduced. Accordingly, a high-quality FPC capable of high-density mount can be produced.

1. A polyimide film produced by a continuous process, wherein a coefficient of humidity expansion ratio (b)/(a) between a coefficient of humidity expansion (b) in a direction perpendicular to a molecular orientation axis and a coefficient of humidity expansion (a) in a direction parallel to the molecular orientation axis is 1.01 to 2.00 across an entire width of the polyimide and a difference between a maximum coefficient of humidity expansion ratio and a minimum coefficient of humidity expansion ratio is 0.30 or less.

2. The polyimide film according to claim 1, wherein the coefficient of humidity expansion in the direction parallel to the molecular orientation axis is 3.0 ppm/% RH to 15.0 ppm/ % RH across the entire width of the polyimide film.

3. The polyimide film according to claim 1, wherein the difference between a maximum molecular orientation angle and a minimum molecular orientation angle of the polyimide film is 40° or less across the entire width of the polyimide film.

4. The polyimide film according to claim 2, wherein the difference between a maximum molecular orientation angle and a minimum molecular orientation angle of the polyimide film is 40° or less across the entire width of the polyimide film.

5. The polyimide film according to claim 1, wherein a molecular orientation angle of the polyimide film is with in 0±20° with respect to a machining direction, where the machining direction is 0° (MD direction) of a continuous process for producing the polyimide film across the entire width of the polyimide film.

6. The polyimide film according to claims 2, wherein a molecular orientation angle of the polyimide film is with in 0∓20° with respect to a machining direction, where the machining direction is 0° (MD direction) of a continuous process for producing the polyimide film across the entire width of the polyimide film.

7. The polyimide film according to claim 3, wherein a molecular orientation angle of the polyimide film is with in 0±20° with respect to a machining direction, where the machining direction is 0° (MD direction) of a continuous process for producing the polyimide film across the entire width of the polyimide film.

8. The polyimide film according to claim 4, wherein a molecular orientation angle of the polyimide film is with in 0±20° with respect to a machining direction, where the machining direction is 0° (MD direction) of a continuous process for producing the polyimide film across the entire width of the polyimide film.

9. A laminate comprising the polyimide film according to claim 1.

10. A laminate comprising the polyimide film according to claim 2.

11. A laminate comprising the polyimide film according to claim 3.

12. A laminate comprising the polyimide film according to claim 4.

13. A laminate comprising the polyimide film according to claim 5.

14. A laminate comprising the polyimide film according to claim 6.

15. A laminate comprising the polyimide film according to claim 7.

16. A laminate comprising the polyimide film according to claim 8.
